(19) United States
(12) Patent Application Publication
(10) Pub. No.: US 2015/0373897 A1
(43) Pub. Date: Dec. 31, 2015

(54) Single Pass Raised Bed Preparation System

(71) Applicants: Richard James Larsen, Cowra (AU); David Larsen, Cowra NSW (AU)

(72) Inventors: Richard James Larsen, Cowra (AU); David Larsen, Cowra NSW (AU)

(21) Appl. No.: 14/722,163

(22) Filed: May 27, 2015

Related U.S. Application Data
(60) Provisional application No. 62/004,901, filed on May 30, 2014.

(51) Int. Cl. A01B 49/02; A01B 63/00; A01B 5/00

(52) U.S. Cl. CPC A01B 49/027; A01B 5/00; A01B 63/008

(57) ABSTRACT

The disclosed single pass raised bed preparation system makes use of one or more rows of adjustable height compact discs (4), to mulch up stubble and loosen the soil in the depressed furrows prior to the action of a bed-forming implement (6) mounted behind the discs. At the same time the raised beds are cultivated by two rows of compact discs, with the second row (2) opposite handed to the leading row (1). A roller or crumbler (7) levels and conditions the beds, so that both the beds and the furrows are restored in a single pass to a condition ready for sowing.

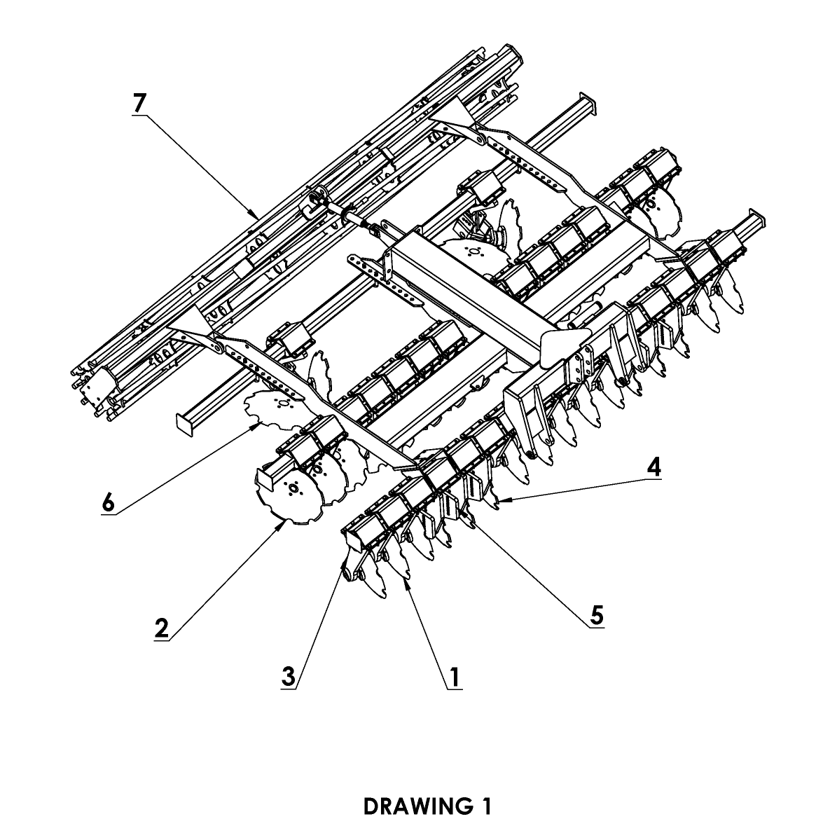

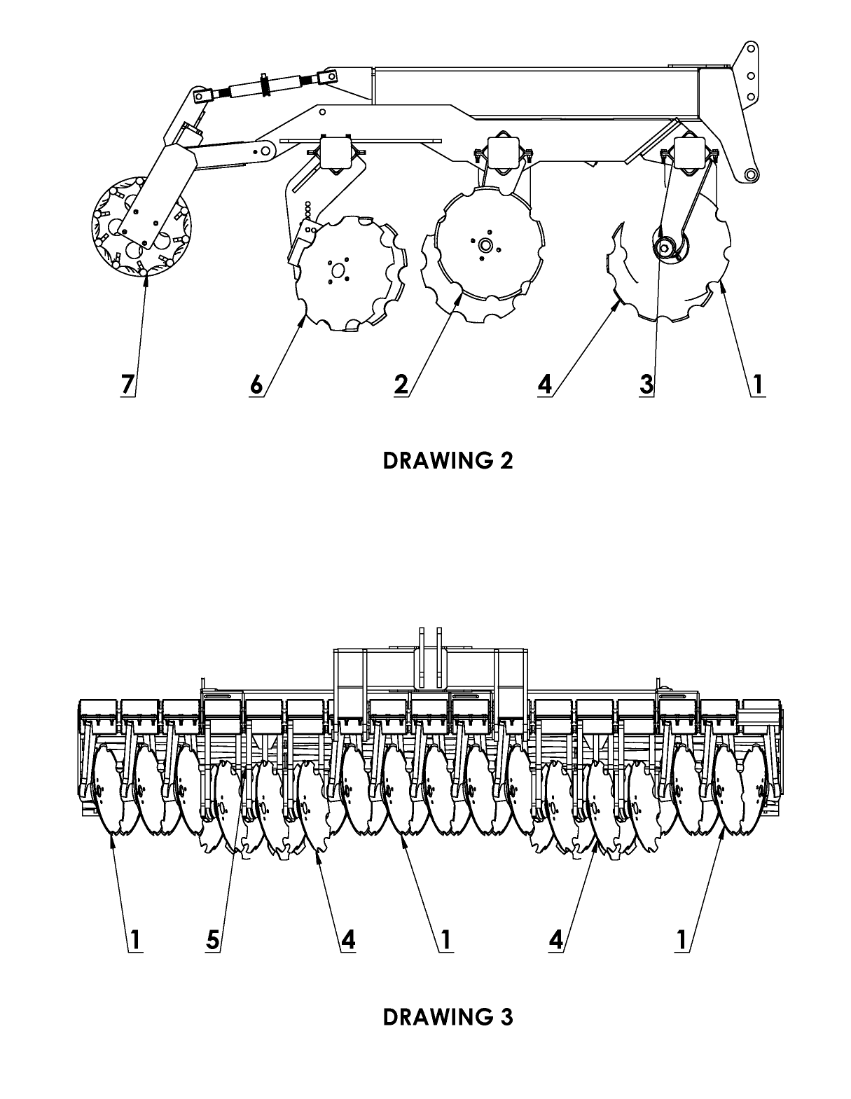

### BACKGROUND

Raised beds in agriculture typically consist of evenly spaced beds used for the sowing of crops. These beds are separated by depressed furrows, which correspond with the tyre positions of tractors and other machinery. The furrows are usually set at intervals of approximately 2 m. The difference in level between the beds and the furrows presents a difficulty when pre-existing beds are prepared for sowing, particularly when the beds and furrows are partially or wholly covered with weeds and stubble.

Typically, preparation of a field with raised beds requires many passes using different types of machines to remove weeds, cultivate, and level the soil to create new raised beds. A problem arises when trash and weeds collect in the low profile of the furrows in greater proportion than the beds, impeding the operation of implements which restore the furrows.

Another problem can arise when the wheels of the tractors compact the soil in the furrows. This can impede the absorption of moisture into the raised beds from the furrows.

The invention described herein is designed to overcome these problems and allow an area of alternate raised beds and furrows to be prepared for sowing in a single pass. The invention consists of a tilling arrangement which utilises the non-power driven, compact disc principle developed by K-Line Industries, in combination with bed-forming implements to simultaneously prepare the beds and furrows.

### SUMMARY

The tilling arrangement consists of rows of evenly spaced, ground-driven compact discs, as in the K-Line Industries Speedtiller system or equivalent. The arrangement is shown in the attached diagrams. The beds are cultivated by a row of compact discs (1), with a second row of opposite-handed discs (2) behind that. The discs are located on rubber-mounted jump arms (3), and effectively break up and mix the soil and plant residue on the beds.

At intervals in the disc rows which correspond with the position of the furrows some compact discs (4) are installed on adjustable height jump arms (5). These can be lowered to suit the level and shape of the furrows, and allow the discs to mulch up the stubble and loosen the soil in the furrows. The discs on the adjustable height jump arms can be installed in either or both of the disc rows.

The position and height of the adjustable height disc blades (4) on these two rows of discs can be lowered and adjusted to help remove compacted soil that occurs on the outer edges of the furrow from the tractor and implement wheels which impedes the absorption of water into the bed area at the time of watering.

Following the compact discs is one or more rows of bed-forming implements (6). These can consist of inclined discs or shaped blades, and restore the final shape of the furrows and beds.

The arrangement can also include rollers or crumblers (7) to condition and level the surface of the beds. These can be positioned either before or after the bed-forming implements.

### DRAWINGS

Drawing 1—This shows an isometric view of a tilling machine with the system incorporated. Two sets of the adjustable height jump arms are shown in this example.

Drawing 2—This shows a side view of the tilling machine, and indicates the difference in level between the standard cultivating discs and those mounted on the adjustable height jump arms, which are lower to correspond with the furrows.

Drawing 3—This shows a front view of the tilling machine, again indicating the height difference between the discs on the two sets of adjustable jump arms and the standard discs between them.

### DESCRIPTION

Preferably, the adjustable height jump arms which form the main component of the system are mounted using rubbers onto the same square tube tool bar that the standard jump arms are mounted on. The number of adjustable height jump arms beside each other in each set is determined by the width of the furrow being cultivated.

Preferably, the adjustable height jump arm is made in two main sections. One section is clamped to the tool bar through the rubber mounts. It incorporates a flat section inclined downwards which has a row of holes at equal spacing.

The second section carries the compact disc with its bearing housing. It incorporates a flat section inclined upwards which has a row of holes at the same spacing as the holes on the first section.

The sections are bolted together through these holes, with the holes aligned to result in the desired position of the disc in relation to the discs on either side of it. The height of individual discs can consequently be set to suit the depth and shape of the furrow being prepared.

It will be appreciated by those skilled in the art that other methods of height adjustment of the discs on the adjustable height jump arms are possible. These include height adjustment by means of hydraulic actuators and by various forms of threaded adjustment rods.

1. A system of soil cultivation to prepare in a single pass, a pre-existing seed bed consisting of alternate raised beds and depressed furrows, which incorporates one or more rows of ground driven compact tilling discs set to operate in the furrows at the required lower depth to loosen compacted soil on the sides of the furrows, and in the raised beds at a shallower depth to mulch and loosen the soil.

2. A system of soil cultivation as described in claim 1 in which the bed surface is prepared by two rows of compact disc blades set at an angle with the second row opposite-handed to the leading row.

3. A system of soil cultivation as described in claim 1 which includes a device to restore the bed and reshape the furrow. This device can be either pairs of rotating disc blades set at opposing angles, or a ditching share that can be adjusted for height, to part the soil and reconstitute the furrow.

4. A system of soil cultivation as described in claim 1 in which the implement is used to restore the bed and furrow shape consisting of appropriately shaped disc blades

5. A system of soil cultivation as described in claim 1 in which the surface of the bed is levelled and conditioned by a roller arrangement or crumbler following the tilling discs, which can be placed before or after the furrow-former.

6. A system of soil cultivation as described in any of the claims 1, 2, 3, 4 and 5, in which the disc blade depth relationship can be adjusted hydraulically or mechanically.

7. A system of soil cultivation as described in any of the claims 1, 2, 3, 4, 5 and 6, which incorporates provision for folding wings to extend the area that can be cultivated in one pass.

8. A system of soil cultivation with reference to the accompanying drawing.
